(19) United States
(12) Patent Application Publication
(10) Pub. No.: US 2013/0109731 A1
(43) Pub. Date: May 2, 2013

(54) ANTIMICROBIAL COMPOSITIONS AND METHODS FOR MAKING SAME

(71) Applicants: Howard S. Rosing, Naples, FL (US); Ronald I. Pass, Naples, FL (US)

(72) Inventors: Howard S. Rosing, Naples, FL (US); Ronald I. Pass, Naples, FL (US)

(73) Assignee: BioMed Protect, LLC, St. Louis, MO (US)

(21) Appl. No.: 13/286,343

(22) Filed: Nov. 1, 2011

(51) Int. Cl. A01N 43/50; B05D 3/00; B05D 3/02; A01P 1/00; B05D 1/18

(52) U.S. Cl. 514/389; 427/381

(57) ABSTRACT

An antimicrobial composition comprising water, an organic acid such as citric acid, chitosan, and one or more heterocyclic N-halamine compounds such as MDMH and/or DMDMH.

### BACKGROUND

There are many reasons for wanting to incorporate antimicrobial agents into textiles. For instance, antimicrobial activity may enhance the durability of textiles by inhibiting the growth of bacteria and fungi that live in textiles and cause damage to their components. Textiles with antimicrobial activity also prevent the creation of odors by preventing or reducing microbes from feeding on the organic materials in the textile. Additionally, antimicrobial treated textiles may kill pathogenic microbes thereby protecting the wearer from exposure to disease agents.

Other uses of antimicrobial treated textiles include wound care. For example, a medical bandage that has been treated with antimicrobial agents offers the wound a favorable environment for healing and further prevents bacterial organisms from growing at the site. Furthermore, antimicrobial treated textiles may prevent disease-causing microorganisms from surviving or even proliferating on the surface or in the internal crevices of the textile when the cloth soaks up or is exposed to contaminated fluid. The use of antimicrobial cloths may also prevent the cross contamination of bacterial infections between people or patients in a close environment, such as in a hospital, prison, or on a military base.

Antimicrobial bedding linens offer an enhanced level of hygiene and security in hospital or hotel rooms. Their use may limit the transfer of bacterial disease in hospitals and lower the rates at which hospitalized patients acquire nosocomial infections, which have been increasing in frequency in recent years.

While textiles possessing antimicrobial characteristics have been introduced in recent years, most of these textiles are prepared by adding antimicrobial agents to the textile. Specifically, antimicrobial agents are impregnated into or coated onto the fibers of the textile during the manufacturing process. The antimicrobial agents are not, however, permanently bound to the textile fibers and are thus prone to leaching, such that these agents are absorbed by human skin. In addition to leaching, the antimicrobial agents are not able to withstand numerous washings, so that the antimicrobial effect may not last long. While certain treated textiles are known to be regenerable after exhaustion by the treated textiles, use of chlorine bleach is necessary to regenerate antimicrobial activity.

Thus, there is a need to overcome the aforementioned disadvantages. Current antimicrobial treatment of textile leaves a need for a means of providing various textiles with minimal leaching, more permanent antimicrobial characteristics, and that does not require use of chlorine bleach for regenerable antimicrobial properties.

### BRIEF DESCRIPTION OF THE DRAWINGS

FIG. 1 is a flow diagram of a method for treating a textile with an antimicrobial composition.

### DETAILED DESCRIPTION

Although particular embodiments are described herein, those embodiments comprise mere examples of the disclosed inventions and are not intended to limit this disclosure. Terminology used herein serves the purpose of describing those embodiments, and is not intended to be limiting, since the scope of the present disclosure will be limited only by the appended claims.

Where a range of values is provided, each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Ratios, concentrations, amounts, and other numerical data can be expressed herein in a range format. Such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. For illustration purposes only, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include ±1%, ±2%, ±3%, ±4%, ±5%, ±6%, ±7%, ±8%, ±9%, or ±10%, or more of the numerical value(s) being modified. The term “about” or “approximately” can include an acceptable error for a particular value as determined by one of ordinary skill in the art of general chemistry, organic chemistry, polymer chemistry, materials science, which depends in part on how the value is measured or determined. In certain embodiments, “about” can mean one or more standard deviations.

As will be apparent to those of skill in the art upon reading this disclosure, each of the individual embodiments described and illustrated herein has discrete components and features which can be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of general chemistry, organic chemistry, polymer chemistry, materials science, and the like, which are within the skill of the art. Such techniques are explained fully in the literature.

Prior to describing the various embodiments, the following definitions are provided and should be used unless otherwise indicated.

### Definitions

Unless otherwise defined, all technical and scientific terms used herein have the same meaning as commonly understood by one of ordinary skill in the art of general chemistry, organic chemistry, polymer chemistry, and materials science. Although methods and materials similar or equivalent to those described herein can be used in the practice or testing of the present disclosure, suitable methods and materials are described herein.

As used in the specification and the appended claims, the singular forms “a,” “an,” and “the” may include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

As used herein, “DMDMH”, or “DMDM hydantoin” refers to 1,3-dimethylol-5,5-dimethylhydantoin,

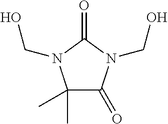

[i.e., 1,3-bis(hydroxymethyl)-5,5-dimethylhydantoin], which has the CAS Number 6440-58-0.

As used herein, “MDMH” or “MDM hydantoin” refers to 1-methylol-5,5-dimethylhydantoin,

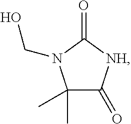

[i.e., 1-(hydroxymethyl)-5,5-dimethylhydantoin] which has the CAS number 116-25-6.

As used herein, “chitosan” refers to

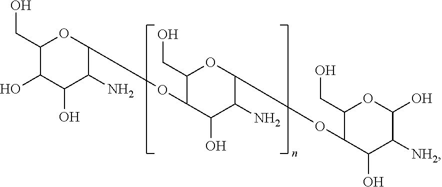

wherein n is about 3 to about 6000.

As used herein, “textile” refers to a material containing natural and/or artificial fibers. In some cases, the textile comprises about 5% to about 100% cellulose. The antimicrobial compositions of the present disclosure may be applied during or after processing to textiles such as clothing, including uniforms, socks, undergarments; medical textiles, including patent drapes, gauzes, surgeon's gowns, caps, masks, and hospital bedding and curtains; and household textiles, including carpet, bedding, and drapes.

As used herein, “antimicrobial” or “antimicrobial composition” refers to a substance capable of killing or inhibiting the growth of microorganisms, such as bacteria (e.g., Streptococcus, Enterococcus, Bacteroidaceae, Enterobacteriaceae, Vibrionaceae, Pasteurellae, Acinetobacter, Pseudomonadaceae, Escherichia coli, Staphylococcus aureus, Shigalla sonnei, Salmonella enteritidis, Salmonella choterse-suis, Pseudomonas aeruginosa, VRE, MRSA, Proteus mirabilis, Campylobacter jejuni, and Brevibacterium), viruses (e.g., MS-2 Bacteriophage, Canduda albicans, influenza strain A, influenza strain B, and Swine Influenza), fungi (e.g., Malassezia furfur and Trichophyton mentagrophytes), and protozoans.

### Example Embodiments

Embodiments of the present disclosure include antimicrobial compositions, methods of preparing these antimicrobial compositions, textiles including antimicrobial compositions, and methods for treating a textile with an antimicrobial composition. Accordingly, embodiments of the present disclosure include textiles treated with the antimicrobial compositions described below and methods of applying these antimicrobial compositions to textiles. Examples of textiles that may be treated with the antimicrobial compositions described below include medical textiles, housing textiles, and textiles related to garments.

Embodiments of the antimicrobial compositions of the present disclosure may be added to a variety of textiles. Textiles that have been treated with the antimicrobial compositions of the present disclosure demonstrate antimicrobial activity. Moreover, the antimicrobial effect demonstrated by these treated textiles is highly durable, such that these textiles may be washed numerous times with little to no loss of antimicrobial activity. In certain embodiments, the antimicrobial aspect of the textile is renewable or regenerable without the addition of chlorine bleach. Additionally, textiles treated with the antimicrobial compositions of the present disclosure demonstrate negligible leaching and are thus unlikely to pose health concerns to those coming into contact with these treated textiles.

An embodiment of the present disclosure includes antimicrobial compositions in the form of an aqueous solution consisting of water, an organic acid present in about 0.025% to about 10% by weight of solution, chitosan present in about 0.0125% to about 10% by weight of solution, as well as one or more heterocyclic N-halamine compounds present in about 1.0% to about 90% by weight of solution. Examples of organic acids suitable for use in the antimicrobial compositions of the present disclosure include, but are not limited to, citric acid, acetic acid, lactic acid, formic acid, and oxalic acid. Examples of heterocyclic N-halamine compounds suitable for use in the antimicrobial compositions of the present disclosure include, but are not limited to MDMH, DMDMH; monomethylolated and dimethylolated derivatives of 2,2,5,5-tetramethyl-1,3-imidazolidin-4-one, 6,6-dimethyl-1,3,5-triazine-2,4-dione, 4,4,5,5-tetramethyl-1,3-imidazolidin-2-one, cyanuric acid, and 5,5-dimethylhydantoin; and monomethoxylated and dimethoxylated derivatives of monomethylolated and dimethylolated derivatives of 2,2,5,5-tetramethyl-1,3-imidazolidin-4-one, 6,6-dimethyl-1,3,5-triazine-2,4-dione, 4,4,5,5-tetramethyl-1,3-imidazolidin-2-one, cyanuric acid, 5,5-dimethylhydantoin. Examples of the monomethoxylated and dimethoxylated compounds are monomethoxymethyl-5,5-dimethylhydantoin and 1,3-dimethoxymethyl-5,5-dimethylhydantoin, respectively.

One embodiment of the present disclosure includes an aqueous solution consisting of water, citric acid, chitosan, and DMDMH, e.g:, an aqueous solution consisting of water, about 0.025% to about 0.1% of citric acid by weight of solution, about 0.0125% to about 0.1% chitosan by weight of solution, and about 1.0% to about 30% DMDMH by weight of solution.

One embodiment of the present disclosure includes an aqueous solution consisting of water, citric acid, chitosan, and MDMH, e.g., an aqueous solution consisting of water, about 0.025% to about 0.1% of citric acid by weight of solution, about 0.0125% to about 0.1% chitosan by weight of solution, and about 1.0% to about 30% MDMH by weight of solution.

One embodiment of the present disclosure includes an aqueous solution consisting of water, citric acid, chitosan, DMDMH, and MDMH, e.g., an aqueous solution consisting of water, about 0.025% to about 0.1% of citric acid by weight of solution, about 0.0125% to about 0.1% chitosan by weight of solution, about 0.7% to about 20% DMDMH by weight of solution, and about 0.7% to about 20% MDMH by weight of solution.

In addition to the aforementioned embodiments, embodiments of the present disclosure may also include compositions comprising the antimicrobial compositions of the present disclosure. For example, embodiments of the present disclosure may include each of the ingredients of the antimicrobial compositions as described and further include other compounds, such as additives used to ready the antimicrobial composition of the present disclosure for application to textiles. Examples of additives that may be used in conjunction with the antimicrobial compositions of the present disclosure include, but are not limited to, an ionic halide salt, an organic acid, and water. Examples of ionic halide salts suitable for use as treatment solutions for use in conjunction with the antimicrobial compositions of the present disclosure include, but are not limited to, magnesium chloride, magnesium bromide, calcium chloride, calcium bromide, potassium chloride, and combinations thereof.

One embodiment of the present disclosure includes an aqueous solution comprising water, an organic acid present in about 0.025% to about 10% by weight of solution, chitosan present in about 0.0125% to about 10% by weight of solution, and one or more N-halamine compounds (e.g. MDMH and/or DMDMH) present in about 1.0% to about 90% by weight of solution. The solution can be diluted with water, pH adjusted to about 1.0 to about 5.0 using an organic acid (e.g., citric acid, acetic acid, and/or lactic acid), and can further comprise an ionic halide salt (e.g., magnesium chloride, magnesium bromide, and/or calcium chloride) present in about 0.0006% to about 10% by weight of solution.

One embodiment of the present disclosure includes an aqueous solution comprising water, citric acid, chitosan, and DMDMH, e.g., an aqueous solution of water, about 0.025% to about 0.1% of citric acid by weight of solution, about 0.0125% to about 0.1% chitosan by weight of solution, and about 1.0% to about 30% DMDMH by weight of solution. The solution can be diluted with water, pH adjusted to about 3.0 to about 3.5 using citric acid, and can further comprise magnesium chloride present in about 0.0006% to about 0.006% by weight of solution.

One embodiment of the present disclosure includes an aqueous solution comprising water, citric acid, chitosan, and MDMH, e.g., an aqueous solution consisting of water, about 0.025% to about 0.1% of citric acid by weight of solution, about 0.0125% to about 0.1% chitosan by weight of solution, and about 1.0% to about 30% MDMH by weight of solution. The solution can be diluted with water, pH adjusted to about 2.5 to about 5.0 using citric acid, and can further comprise magnesium chloride present in about 0.0006% to about 0.006% by weight of solution.

One embodiment of the present disclosure includes an aqueous solution comprising water, citric acid, chitosan, DMDMH, and MDMH, e.g., an aqueous solution consisting of water, about 0.025% to about 0.1% of citric acid by weight of solution, about 0.0125% to about 0.1% chitosan by weight of solution, about 0.7% to about 30% DMDMH by weight of solution, and about 0.7% to about 20% MDMH by weight of solution. The solution can be diluted with water, pH adjusted to about 3.0 to about 3.5 using citric acid, and can further comprise magnesium chloride present in about 0.0006% to about 0.006% by weight of solution.

One embodiment of the present disclosure includes a method of treating textiles with the antimicrobial compositions of the present disclosure. The textiles can be treated by either applying the antimicrobial composition to the textile, or immersing the textile in the antimicrobial composition. For example, textiles may be sprayed with the antimicrobial compositions of the present disclosure. Alternatively, textiles may be dipped into baths of the antimicrobial compositions of the present disclosure. Regardless, treatment results in a textile composing an antimicrobial composition. Addition of the antimicrobial compositions of the present disclosure to such textiles results in the heterocyclic N-halamine compound covalently bonding to the cellulose.

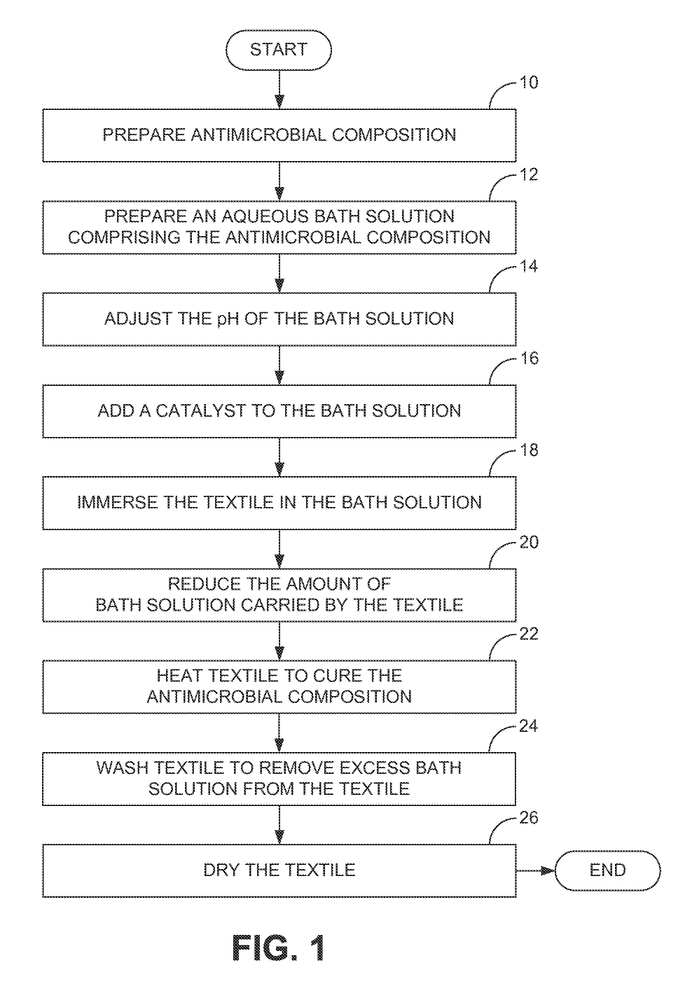

FIG. 1 illustrates an example embodiment of a method for treating a textile with an antimicrobial composition. In some embodiments, the antimicrobial composition comprises a composition that includes water, an organic acid, chitosan, and one or more heterocyclic N-halamine compounds. Although the various actions of the example method are described in a particular order, it is noted that several of the actions identified in FIG. 1 and described below can be performed in an alternative order without effecting the final result.

Beginning with block 10, an aqueous antimicrobial solution is prepared. Once the antimicrobial composition has been prepared, an aqueous bath solution that comprises the antimicrobial solution and water can be prepared, as indicated in block 12. The volume of the bath solution and the amount of aqueous antimicrobial solution that is used depends upon the textile. For example, approximately 468 kilograms (kg) of water and approximately 31 kg of aqueous antimicrobial solution can be used to treat a 100% cotton textile weighing 500 kg. For a 65% cotton fabric of the same weight, approximately 471 kg of water and approximately 29 kg of aqueous antimicrobial solution can be used. For a 35% cotton fabric of the same weight, approximately 473 kg of water and approximately 27 kg of aqueous antimicrobial solution can be used. In some embodiments the concentration of the aqueous antimicrobial solution is more diluted with water as the percentage of cellulosic material in the textile is reduced.

Next, with reference to block 14, the pH of the bath solution can be adjusted, if necessary. In some embodiments, the pH is adjusted to be less than 3.5 by adding citric acid as needed.

Referring next to block 16, a catalyst is added to the bath solution. In some embodiments, magnesium chloride is used as the catalyst. By way of example, 250 grams of magnesium chloride can be added for every approximately 40 kg of bath solution.

At this point, the textile can be immersed in the bath solution, as indicated in block 18, to apply the antimicrobial composition to the textile. In some embodiments, the textile is immersed in a tank that holds the bath solution using a continuous feed process. As indicated in block 20, the amount of bath solution carried by the textile can then be reduced. In some embodiments, the textile is run through squeeze rollers or placed in a centrifugal separator so that excess bath solution is extracted from the exposed wet textile. In some embodiments, approximately 50% to 95% of the bath solution that is absorbed by the textile is extracted. In some embodiments, the textile is approximately 50% to 150% heavier than before the addition of the bath solution after the excess bath solution is extracted so that a significant amount of solution remains within the textile before curing is performed.

The textile is next heated to cure the antimicrobial composition in place on the textile, as indicated in block 22. In some embodiments, the textile is heated at a temperature of approximately 90° C. to 195° C. for at least 15 seconds. For example, the textile can be heated for approximately 15 to 180 seconds. In other embodiments, the textile is heated at a temperature of approximately 150° C. to 170° C. for approximately 30 to 5 minutes. In some cases, prolonged curing can result in prolonged antimicrobial effect. For example, curing for 30 seconds may result in antimicrobial effect that lasts approximately 25 washings while curing for at least 180 seconds may result in antimicrobial effect that lasts approximately 100 washings or more.

The extent of curing that is needed, both in terms of temperature and time, can depend upon certain factors. For instance, higher concentrations of aqueous bath solution may enable lower curing temperatures. As an example, an antimicrobial composition comprising 0.4% citric acid by weight of solution, 0.4% chitosan by weight of solution, 22.6% DMDMH by weight of solution, 21.4% MDMH by weight of solution and 55.2% H₂O by weight of solution can be diluted 8 times with water and be cured at approximately 120° C., or can be diluted 16 times with water and be cured at approximately 140° C. In some cases, curing temperatures below 100° C. (the boiling point of water) are possible when relatively high concentrations of bath solutions are used. In addition, soaking the textile in the bath solution as well as increasing the duration of curing can enable the curing temperature to be reduced, such as at or below 90° C. For example, the textile can in some cases be soaked in the bath solution for approximately 15 minutes and then cured at a temperature of approximately 90° C. for approximately 45 minutes. As another example, the textile can be soaked in the bath solution for approximately 30 minutes and then cured at a temperature of approximately 35° C. for approximately 120 minutes. It therefore can be appreciated that the bath concentration, soaking time, cure temperature, and cure time can be adjusted and still obtain desired antimicrobial functionality.

The textile can be heated in an oven or other heating unit. In some embodiments, the curing temperature is set based on the percentage of cellulosic material (e.g., cotton) in the textile. For textiles that are 100% cotton, an example curing temperature may be 150° C. in a tumbler dryer. For textiles that are 35% cotton, an example curing temperature may be 175° C. in the tumbler dryer. Furthermore, the antimicrobial effect may last longer (e.g., more than two years) if the curing temperature is higher, for example over 150° C. In some embodiments, infrared (IR) or radiant heating can be used. In other embodiments, ultraviolet (UV) curing can be used.

In some embodiments, textiles are treated during their manufacturing process. In other embodiments, finished textiles that are already in commercial use are treated during a normal wash cycle. The antimicrobial effect is substantially the same whether the treatment occurs during the manufacturing process or during a wash cycle.

After curing, the textile can be washed (block 24) in warm or cold water to remove any excess bath solution from the textile and dried (block 26), for example at a typical dryer temperature of 95° C.

The antimicrobial effect will eventually dissipate with repeated washing of the textile. In some embodiments, the durability of the treatment depends upon the amount of cellulosic material the textile comprises. For example, textiles with a smaller percentage of cellulosic material (e.g. 15% cotton or less by weight) may lose the antimicrobial effect after only 100 washings, while textiles made of 100% cellulosic material (e.g., 100% cotton) may not lose the antimicrobial effect for over 200 washings. Whichever the case, the antimicrobial effect can be reinstated using the treatment process described above.

Irrespective of the manner in which antimicrobial activity is imparted to the textile, the addition of the antimicrobial compositions results in the heterocylic N-halamine compound and/or the chitosan covalently bonding to the cellulose:

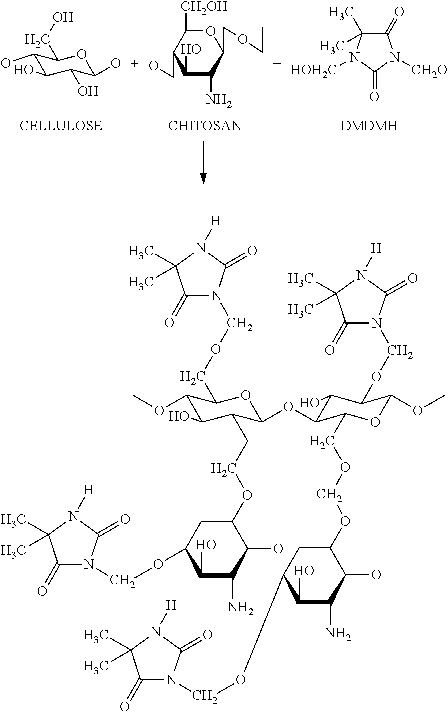

### EXAMPLES

The following synthetic and biological examples are offered to illustrate embodiments of the present disclosure, and are not to be construed in any way as limiting the scope of the disclosure. In the examples below, abbreviations have their generally accepted meanings.

### Example 1

10 g of chitosan,

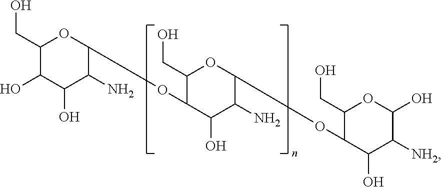

and 10 g of citric acid,

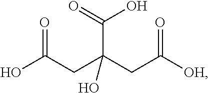 [SMILES: O=C(O)CC(O)(CC(=O)O)C(=O)O]

are dissolved in 980 g of H₂O. The resulting solution is combined with 1500 g of a solution containing 55% of DMDMH,

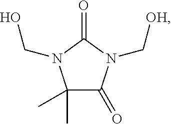

by weight of solution to produce approximately 2500 g of an antimicrobial composition which is approximately:
0.4% citric acid by weight of solution,
0.4% chitosan by weight of solution,
33% DMDMH by weight of solution, and
66.2% H₂O by weight of solution.

The antimicrobial composition is then diluted 16 times (16×) with H₂O to produce a final antimicrobial composition which is approximately:
0.025% citric acid by weight of solution,
0.025% chitosan by weight of solution,
2.06% DMDMH by weight of solution, and
97.89% H₂O by weight of solution.

### Example 2

10 g of chitosan,

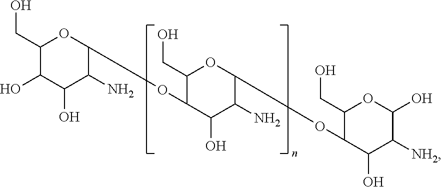

and 10 g of citric acid,

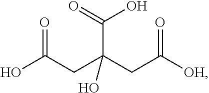 [SMILES: O=C(O)CC(O)(CC(=O)O)C(=O)O]

are dissolved in 980 g of H₂O. The resulting solution is combined with 1500 g of a solution containing 55% of MDMH,

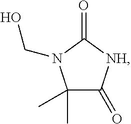

by weight of solution to produce approximately 2500 g of an antimicrobial composition which is approximately:
0.4% citric acid by weight of solution,
0.4% chitosan by weight of solution,
33% MDMH by weight of solution, and
66.2% H₂O by weight of solution.

The antimicrobial composition is then diluted 16 times (16×) with H₂O to produce a final antimicrobial composition which is approximately:
0.025% citric acid by weight of solution,
0.025% chitosan by weight of solution,
2.06% DMDMH by weight of solution, and
97.89% H₂O by weight of solution.

### Example 3

10 g of chitosan,

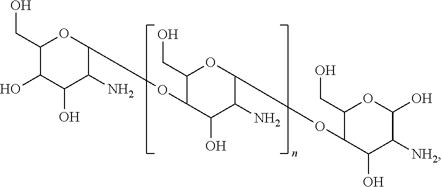

and 10 g of citric acid,

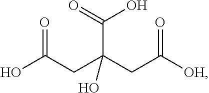 [SMILES: O=C(O)CC(O)(CC(=O)O)C(=O)O]

are dissolved in 780 g of H₂O. The resulting solution is combined with 1700 g of a solution containing 33.2% by weight DMDMH,

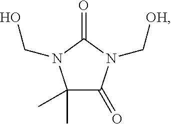

### and 31.5% MDMH,

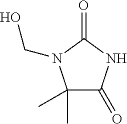

to produce an antimicrobial composition which is approximately:
0.4% citric acid by weight of solution,
0.4% chitosan by weight of solution,
22.6% DMDMH by weight of solution, and
21.4% MDMH by weight of solution.
55.2% H₂O by weight of solution.

The antimicrobial composition is then diluted 16 times (16×) with H₂O to produce a final antimicrobial composition which is approximately:
0.025% citric acid by weight of solution,
0.025% chitosan by weight of solution,
1.41% DMDMH by weight of solution, and
1.34% MDMH by weight of solution.
97.20% H₂O by weight of solution.

### Example 4

The pH of the antimicrobial composition of Example 1, which is approximately:
0.025% citric acid by weight of solution,
0.025% chitosan by weight of solution,
2.06% DMDMH by weight of solution, and
97.89% H₂O by weight of solution,

is kept in the range of about 3.0 to about 3.5 using citric acid. 250 g of magnesium chloride is added to the solution to produce an antimicrobial composition for use in textile treatment.

### Example 5

The pH of the antimicrobial composition of Example 2, which is approximately:
0.025% citric acid by weight of solution,
0.025% chitosan by weight of solution,
2.06% DMDMH by weight of solution, and
97.89% H₂O by weight of solution,

is kept in the range of about 3.0 to about 3.5 using citric acid. 250 g of magnesium chloride is added to the solution to produce an antimicrobial composition for use in textile treatment.

### Example 6

The pH of the antimicrobial composition of Example 3, which is approximately:
0.025% citric acid by weight of solution,
0.025% chitosan by weight of solution,
1.41% DMDMH by weight of solution, and
1.34% MDMH by weight of solution.
97.20% H₂O by weight of solution,

is kept in the range of about 3.0 to about 3.5 using citric acid. 250 g of magnesium chloride is added to the solution to produce an antimicrobial composition for use in textile treatment.

We claim:

1. An aqueous solution consisting of:
H₂O, about 0.025% to about 0.1% 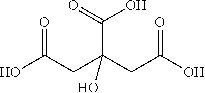 [SMILES: O=C(O)CC(O)(CC(=O)O)C(=O)O]
by weight of solution, 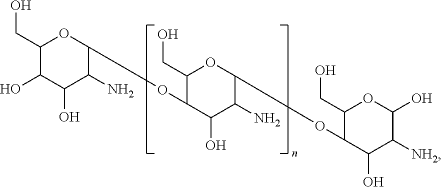
and
an additional compound selected from a group consisting of: 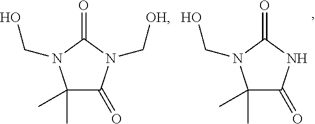
and a combination thereof,
wherein n is about 3 to about 6000.

2. The solution of claim 1, wherein the additional compound is

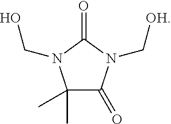

3. The solution of claim 1, wherein the additional compound is

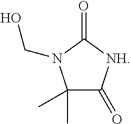

4. The solution of claim 1, wherein the additional compound is the combination of

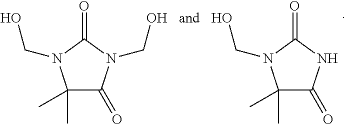

5. The solution of claim 2 consisting of:
H₂O, about 0.025% to about 0.1% of 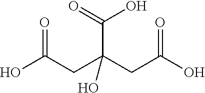 [SMILES: O=C(O)CC(O)(CC(=O)O)C(=O)O]
by weight of solution,
about 0.0125% to about 0.1% of 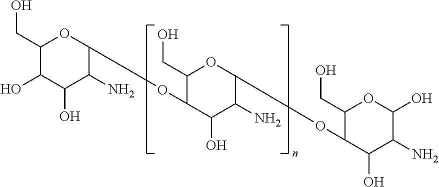
by weight of solution; and
about 1.0% to about 30% of 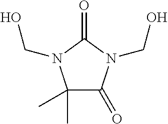
by weight of solution.

6. The solution of claim 3 consisting of:
H₂O, about 0.025% to about 0.1% of 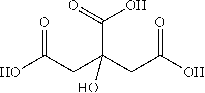 [SMILES: O=C(O)CC(O)(CC(=O)O)C(=O)O]
by weight of solution;
about 0.0125% to about 0.1% of 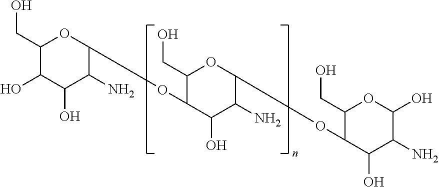
by weight of solution; and
about 1.0% to about 30% of 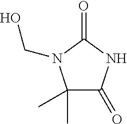
by weight of solution.

7. The solution of claim 4 consisting of:
H₂O, about 0.025% to about 0.1% of 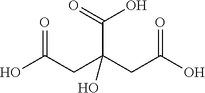 [SMILES: O=C(O)CC(O)(CC(=O)O)C(=O)O]
by weight of solution;
about 0.0125% to about 0.1% of 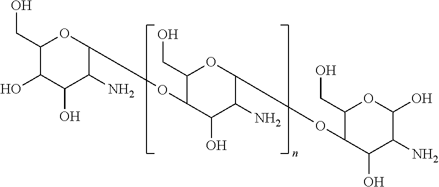
by weight of solution; and
about 0.7% to about 20% of 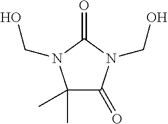
by weight of solution; and
about 0.7% to about 20% of 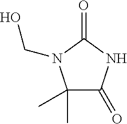
by weight of solution.

8. An aqueous solution comprising:
H₂O, about 0.025% to about 0.1% 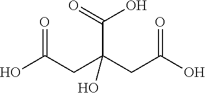 [SMILES: O=C(O)CC(O)(CC(=O)O)C(=O)O]
by weight of solution, 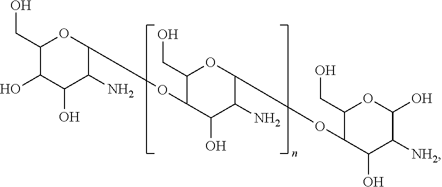
and
an additional compound selected from a group consisting of: 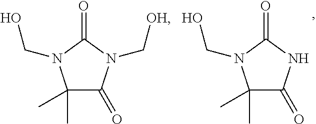
and a combination thereof,
wherein n is about 3 to about 6000.

9. The aqueous solution of claim 8, further comprising MgCl₂.

10. The aqueous solution of claim 8, wherein 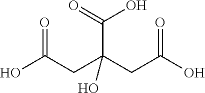 [SMILES: O=C(O)CC(O)(CC(=O)O)C(=O)O]
is present in about 0.025% to about 0.1% by weight of solution, 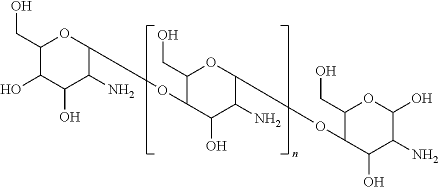
is present in about 0.0125% to about 0.1% by weight of solution, and the additional compound is 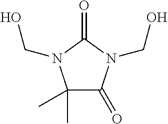
and is present in about 1.0% to about 30% by weight of solution.

11. The aqueous solution of claim 8, wherein 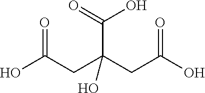 [SMILES: O=C(O)CC(O)(CC(=O)O)C(=O)O]
is present in about 0.025% to about 0.1% by weight of solution, 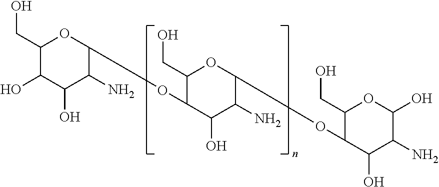
is present in about 0.0125% to about 0.1% by weight of solution, and the additional compound is 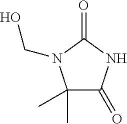
and is present in about 1.0% to about 30% by weight of solution.

12. The aqueous solution of claim 8, wherein 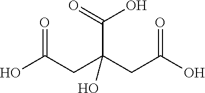 [SMILES: O=C(O)CC(O)(CC(=O)O)C(=O)O]
is present in about 0.025% to about 0.1% by weight of solution, 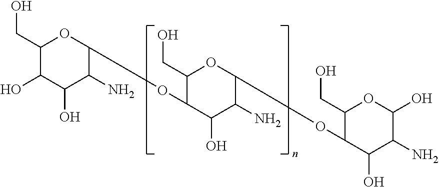
is present in about 0.0125% to about 0.1% by weight of solution, and the additional compounds are 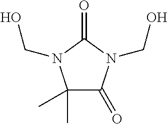
and is present in about 0.7% to about 20% by weight of solution and 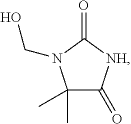
present in about 0.7% to about 20% by weight of solution.

13. A textile treated with the aqueous solution of claim 1.

14. A textile treated with the aqueous solution of claim 8.

15. A method of adding the aqueous solution of claim 1 to a textile, comprising contacting the textile with the aqueous solution of claim 1.

16. A method of adding the aqueous solution of claim 8 to a textile, comprising contacting the textile with the aqueous solution of claim 8.

17. A method for treating a textile with an antimicrobial composition, the method comprising:
preparing an antimicrobial composition that includes water, an organic acid, chitosan, and one or more heterocyclic N-halamine compounds;
preparing an aqueous bath solution that comprises the antimicrobial composition;
immersing a textile in the aqueous bath solution;
reducing the amount of aqueous bath solution carried by the textile so that the textile is approximately 50% to 150% heavier than before the addition of the bath solution;
heating the textile at approximately 90° C. to 195° C. for approximately 15 seconds to 5 minutes to cure the antimicrobial composition;
washing the textile to remove excess aqueous bath solution; and
drying the textile.

18. The method of claim 17, wherein preparing an antimicrobial composition comprises preparing an antimicrobial composition that includes water, citric acid, chitosan, and DMDMH.

19. The method of claim 17, wherein preparing an antimicrobial composition comprises preparing an antimicrobial composition that includes water, citric acid, chitosan, and MDMH.

20. The method of claim 17, wherein preparing an antimicrobial composition comprises preparing an antimicrobial composition that includes water, citric acid, chitosan, DMDMH, and MDMH.

21. The method of claim 17, wherein heating the textile comprises heating the textile at approximately 90° C. to 195° C. for at least approximately 180 seconds.

22. The method of claim 17, further comprising adjusting the pH of the aqueous solution to approximately 1.0 to 5.0 prior to applying the solution to the textile by adding an organic acid to the aqueous solution.

23. The method of claim 17, further comprising adding an ionic halide salt to the aqueous solution prior to applying the solution to the textile.
